(19) United States
(12) Patent Application Publication
(10) Pub. No.: US 2025/0354829 A1
(43) Pub. Date: Nov. 20, 2025

(54) METHOD AND APPARATUS WITH HIGH-DEFINITION MAP GENERATION

(71) Applicant: Samsung Electronics Co., Ltd., Suwon-si (KR)

(72) Inventors: Xiaoshuai HAO, Beijing (CN); Hui ZHANG, Beijing (CN); Mengchuan WEI, Beijing (CN); Yifan YANG, Beijing (CN); Chao ZHANG, Beijing (CN); Weiming LI, Beijing (CN)

(73) Assignee: Samsung Electronics Co., Ltd., Suwon-si (KR)

(21) Appl. No.: 19/067,580

(22) Filed: Feb. 28, 2025

(30) Foreign Application Priority Data
May 20, 2024 (CN) 202410628033.4
Oct. 30, 2024 (KR) 10-2024-0150973

(51) Int. Cl. G01C 21/00; G06V 10/77; G06V 10/774; G06V 10/776; G06V 10/80

(52) U.S. Cl. CPC G01C 21/3841; G06V 10/7715; G06V 10/774; G06V 10/776; G06V 10/806

(57) ABSTRACT

A method of acquiring a high-definition (HD) map and an apparatus performing the method are disclosed. A method executed by an electronic device, according to one embodiment, may include acquiring first data including at least one type of data. The method may include acquiring a map image corresponding to the first data using a first artificial intelligence (AI) network based on the first data.

### CROSS-REFERENCE TO RELATED APPLICATIONS

This application claims the benefit under 35 USC § 119 (a) of Chinese Patent Application No. 202410628033.4 filed on May 20, 2024, in the China National Intellectual Property Administration, and Korean Patent Application No. 10-2024-0150973 filed on Oct. 30, 2024, in the Korean Intellectual Property Office, the entire disclosures of which are incorporated herein by reference for all purposes.

### BACKGROUND

### 1. Field

The following description relates to a method and apparatus with high-definition (HD) map generation.

### 2. Description of Related Art

Autonomous driving may make use of a process of collecting data about the environment around a vehicle while the vehicle is travelling and constructing a map of the environment around the vehicle using the collected data. This process may be implemented through artificial intelligence (AI) technology.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a method performed by an electronic device includes: acquiring first data and second data; and acquiring, based on the first data, a first map image corresponding to the first data, using a first artificial intelligence (AI) network, acquiring, based on the second data, a second map image corresponding to the second data, using the first AI network wherein the acquiring of the first map image includes: based on the first data comprising only one data type, acquiring the first map image based on a first feature extracted from the first data using an encoder corresponding to the only one data type; and wherein the acquiring of the second map image includes: based on the second data comprising data of two data types, generating the second map image based on a second feature acquired from data of the two data types, wherein the second feature acquired is acquired by fusing together features extracted respectively from the data of the two data types using encoders respectively corresponding to the two data types.

The acquiring of the first map image may include enhancing the first feature using a mapping network of the first AI network, based on the first feature of the first data, to acquire a third feature corresponding to the first data. The acquiring of the first map image corresponding to the first data using the first AI network based on the first data may include acquiring, based on the third feature, the first map image, using a decoder of the first AI network.

The enhancing of the first feature may include enhancing the first feature using a first mapping network or a second mapping network different from the first mapping network to acquire the third feature.

The acquiring of the first map image corresponding to the first data using the decoder of the first AI network based on the third feature may include, in response to the third feature being acquired using the first mapping network, acquiring the first map image using the decoder of the first AI network based on the third feature and the first feature.

The first feature may include a bird's eye view (BEV) feature, and each of the second features may include a respective other BEV feature.

The first data may include image data collected via a camera or point cloud data collected via a LiDAR.

The method may further include determining a data type of data included in the first data.

In a general aspect, here is provided a method performed by an electronic device. The method may include acquiring a training data set including first samples and second samples respectively related to the first samples. The first samples and the second samples may be of different types. The method may include acquiring, based on the training data set, a fourth feature related to each first sample, a fifth feature related to each second sample, and a sixth feature of each first sample and each second sample related to each first sample, using a second AI network. The method may include performing a prediction using the second AI network, based on the fourth feature, the fifth feature, and the sixth feature, to acquire a prediction result corresponding to each sample of the training data set. The method may include training the second AI network based on the prediction result to acquire a first AI network.

The prediction result may include a first image corresponding to each first sample, a second image corresponding to each second sample, and a third image corresponding to each first sample and each second sample related to each first sample.

The acquiring of the fourth feature related to each first sample, the fifth feature related to each second sample, and the sixth feature of each first sample and each second sample related to each first sample, using the second AI network, based on the training data set, may include acquiring the fourth feature using an encoder corresponding to a type of each first sample. The acquiring of the fourth feature related to each first sample, the fifth feature related to each second sample, and the sixth feature of each first sample and each second sample related to each first sample, using the second AI network, based on the training data set, may include acquiring the fifth feature using an encoder corresponding to a type of each second sample. The acquiring of the fourth feature related to each first sample, the fifth feature related to each second sample, and the sixth feature of each first sample and each second sample related to each first sample, using the second AI network, based on the training data set, may include acquiring the sixth feature by fusing the fourth feature of each first sample and the fifth feature of each second sample related to each first sample.

The performing of the prediction using the second AI network may include enhancing the fourth feature, the fifth feature, and the sixth feature, using a mapping network of the second AI network. The performing of the prediction using the second AI network may include acquiring the prediction result, using a decoder of the second AI network, based on the enhanced fourth feature, the enhanced fifth feature, and the enhanced sixth feature.

The training of the second AI network may include determining, based on a prediction result corresponding to a group of related samples, a training loss corresponding to the group of the related samples among the first and second samples. The group of the related samples may include image data and point cloud data collected at the same point in time. The training of the second AI network may include training the second AI network using the training loss.

In a general aspect, an electronic device includes one or more processors, and a memory storing instructions. The instructions may cause, based on being executed individually or collectively by the one or more processors, the electronic device to perform operations that may include acquiring, based on the first data, a map image corresponding to the first data, using a first AI network. The acquiring of the map image may include, in response to the first data including only one data type, acquiring the map image based on a first feature extracted from the first data using an encoder corresponding to the one data type. The acquiring of the map image may include, in response to the first data including two data types, acquiring the map image based on a first feature acquired from the two data types. The first feature acquired from the two data types may be acquired by fusing respective second features extracted respectively from the two data types using encoder corresponding to each of the data types, respectively.

The acquiring of the map image corresponding to the first data using the first AI network based on the first data may include enhancing the first feature using a mapping network of the first AI network, based on the first feature of the first data, to acquire a third feature corresponding to the first data. The acquiring of the map image corresponding to the first data using the first AI network based on the first data may include acquiring the map image corresponding to the first data using a decoder of the first AI network, based on the third feature.

The enhancing of the first feature may is able to be performed by using either a first mapping network or by using a second mapping network, either of which can acquire the third feature.

The acquiring of the map image corresponding to the first data may include, in response to the third feature being acquired using the first mapping network, acquiring the map image using the decoder of the first AI network, based on the third feature and the first feature.

The first feature may include a BEV feature, and each of the second features may include a respective other BEV feature.

The first data may include at least one of image data collected via a camera or point cloud data collected via a light detection and ranging (LiDAR) sensor.

The plurality of operations may further include determining a data type of data included in the first data.

In a general aspect, here is provided a computer-readable storage medium storing instructions, wherein the instructions, when executed by at least one processor, cause the at least one processor to implement the method.

Other features and aspects will be apparent from the following detailed description, the drawings, and the claims.

### BRIEF DESCRIPTION OF THE DRAWINGS

FIG. 1A illustrates an example of operations performed by an electronic device according to one or more example embodiments.

FIG. 1B illustrates an example of operations performed by an electronic device according to one or more example embodiments.

FIG. 2 illustrates an example of a network architecture according to one or more example embodiments.

FIG. 3 illustrates an example of a network architecture according to one or more example embodiments.

FIG. 4 illustrates an example of a mapping network and decoder according to one or more example embodiments.

FIG. 5 illustrates an example of a network architecture according to one or more example embodiments.

FIG. 6 illustrates an example of a robustness test according to one or more example embodiments.

FIG. 7 illustrates an example of the performance of a method according to one or more example embodiments.

FIG. 8 illustrates an example of an electronic device according to one or more example embodiments.

Throughout the drawings and the detailed description, unless otherwise described or provided, the same or like drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

At least some functions of an electronic device according to various example embodiments may be implemented through an artificial intelligence (AI) model. For example, the AI model may be used to implement the electronic device or at least some modules among various modules of the electronic device. In this case, functions associated with the AI model may be performed by a non-volatile memory, a volatile memory, or a processor.

The processor may include one or more processors. The one or more processors may be general-purpose processors (e.g., central processing units (CPUs), application processors (APs), etc.), pure graphics processing units (e.g., graphics processing units (GPUs), vision processing units (VPUs), etc.), AP-specific processors (e.g., neural processing units (NPUs), etc.), and/or combinations thereof.

The one or more processors may control processing input data according to predefined operational rules or AI models stored in the non-volatile memory and the volatile memory. The one or more processors may provide the predefined operational rules or AI models through training or learning.

In this case, such a learning-based provision may involve applying a learning algorithm to multiple pieces of training data to acquire the predefined operational rules or AI models with desired characteristics. In this case, training or learning may be performed on the device or electronic device itself on which an AI model is executed, and/or may be implemented by a separate server, device, or system.

An AI model may include layers of a neural network. Each layer may have weight values and perform a neural network computation by computations between input data of a current layer (e.g., a computational result from a previous layer and/or input data of the AI model) and weight values of the current layer. The neural network may be/include, as non-limiting examples, a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), a deep Q-network, or a combination thereof.

The learning algorithm may involve training a target device (e.g., a robot) using multiple pieces of training data to guide, allow, or control the target device to perform determination and estimation (or prediction). The learning algorithm may include, as non-limiting examples, supervised learning, unsupervised learning, semi-supervised learning, or reinforcement learning.

A method performed by an electronic device according to various example embodiments described herein may be applied to technical fields such as speech, language, image, video, or data intelligence (or smart data).

For example, in the field of speech or language processing, the method performed by the electronic device according to various example embodiments may receive a speech signal, as an analog signal (albeit digitized), via the electronic device (e.g., a microphone) and converts the speech into a text using an automatic speech recognition (ASR) model. The method may also interpret the text and analyze the intent of a user's utterance using a natural language understanding (NLU) model. The ASR model or NLU model may be an AI model, which may be processed by a dedicated AI processor designed with a hardware architecture specified for processing the AI model. The AI model may be acquired/configured by training or learning, or specifically, training the underlying AI model with multiple pieces of training data through a learning algorithm to acquire a predefined operational rule or AI model of a desired feature (or purpose). Language understanding is a technique for recognizing and applying/processing human language/text, such as, for example, natural language processing, machine translation, dialog systems, question answering, or speech recognition/synthesis.

For example, in the field of image or video processing, the method performed by the electronic device according to various example embodiments may generate output data by inputting image data to an AI model, which may be acquired by training or learning. The method performed by the electronic device may relate to AI visual understanding, which is a technique for recognizing and processing objects. It may include, for example, object recognition, object tracking, image retrieval, human recognition, scene recognition, three-dimensional (3D) reconstruction/positioning, or image enhancement.

For example, in the field of smart data processing, the method performed by the electronic device according to various example embodiments may perform prediction in an inference or prediction step using real-time input data using an AI model. A processor of the electronic device may preprocess the data and convert the data into a form suitable for use as an input to the AI model. The AI model may be acquired by training or learning. Here, the expression “acquired by training” may indicate training an underlying AI model with multiple pieces of training data through a learning algorithm to acquire a predefined operational rule or AI model of a desired feature (or purpose). The AI model may be used for inferential prediction, that is, making logical inferences and predictions based on determined information, and may include knowledge-based inference, optimized prediction, preference-based planning or recommendation, and the like.

Technical approaches and effects are described herein with reference to various example embodiments. Unless there is a conflict or inconsistency, the embodiments may be referred to or combined with each other, and common terminology, and similar features and steps included in the embodiments will be described and will not be repeated if deemed redundant.

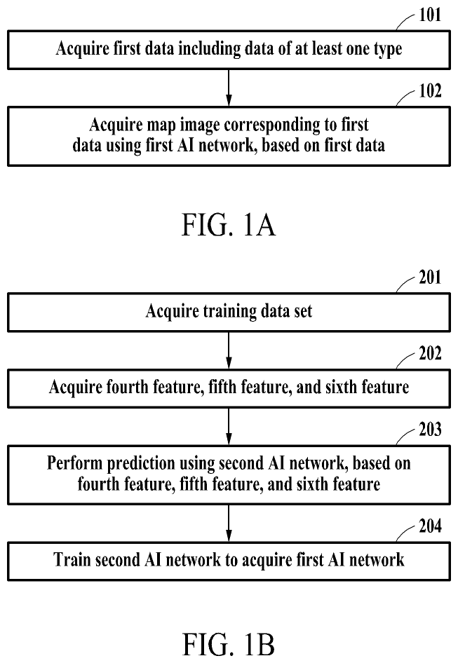

FIG. 1A illustrates an example of operations performed by an electronic device according to one or more example embodiments.

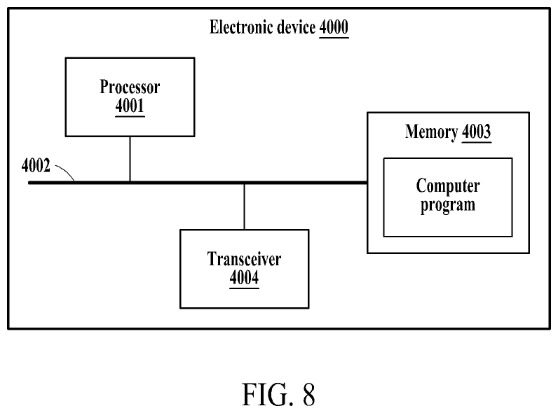

Referring to FIG. 1A, an electronic device (e.g., an electronic device 4000 of FIG. 8) may be a server, cloud computing center equipment, or a terminal.

At operation 101, the electronic device may acquire first data. The first data may include at least one type or modality of data. In one example, the first data may include one type of data. In another example, the first data may include two or more types of data.

The first data may include a first type of data and/or a second type of data. A “type” of data may be a characteristic of the data. For example, the characteristic of the data may include a source and/or a format of the data. In this case, pieces of data having different characteristics may respectively correspond to different types. For example, the type of data may include, but is not limited to, image data collected via a camera, point cloud data collected via light detection and ranging (LiDAR), and/or point cloud data collected via a millimeter wave (mmWave) LiDAR.

A “type” of data may be a modality of the data. The first data may be single-modality data including only one modality, or the first data may be hybrid data (or mixed data) (e.g., multi-modality (or multi-modal) data) including two or more modalities.

The first data may include image data collected via a camera and/or may include point cloud data collected via a LiDAR. In one example, the first data may include only the image data collected via the camera, or only the point cloud data collected via the LiDAR. In another example, the first data may include both the image data collected via the camera and the point cloud data collected via the LiDAR.

In one embodiment, in an autonomous driving scenario, first modality data may be an image of the environment around a vehicle collected via a camera, and second modality data may be point cloud data of the environment collected via a LIDAR. For example, the first data may include camera images of six directions around the vehicle collected via cameras from the same viewing point (the vehicle's viewing point), and point cloud data around the vehicle collected via the LiDAR.

The first data may include three or more types (or modalities) of data. For example, in a case where the first data includes only a single type of data, that type of the first data may be a first type of data, a second type of data, or a third type of data. In a case where the first data includes multiple types of data, the first data may include any two or three of the first type of data, the second type of data, and the third type of data.

At operation 102, the electronic device may acquire a map image corresponding to the first data using a first AI network, by the first AI network performing an inference on the first data.

For example, in a case where the first data includes only one type of data, the electronic device may acquire/generate a first feature of the first data using an encoder corresponding to the type of data. The electronic device may acquire/generate the map image based on the first feature of the first data.

For example, when the first data includes multiple types of data, the electronic device may extract a second features of the respectively corresponding types of data using respectively encoders. That is, there may be an encoder for each type of data that extracts second features from the respective types of first data. The electronic device may fuse the second features to acquire a first feature of the first data. Based on the first feature of the first data, the electronic device may acquire the map image corresponding to the first data.

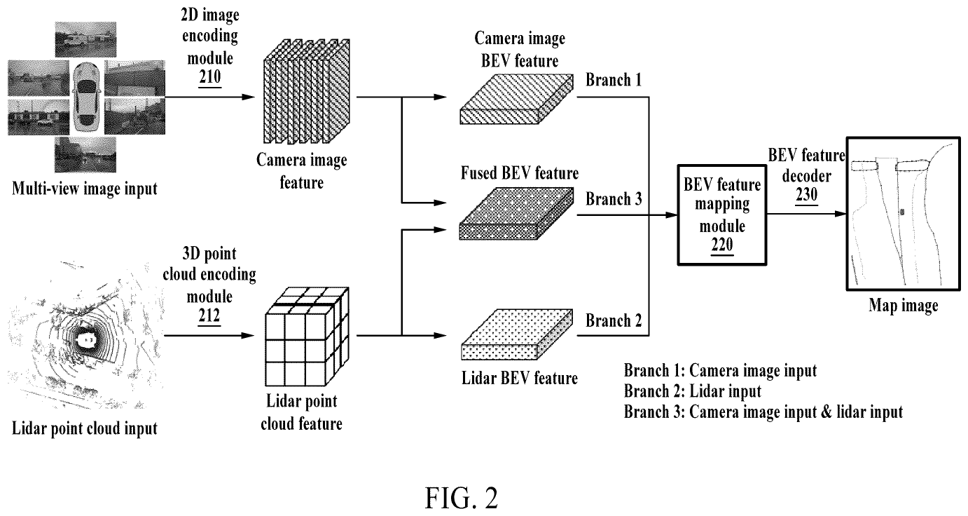

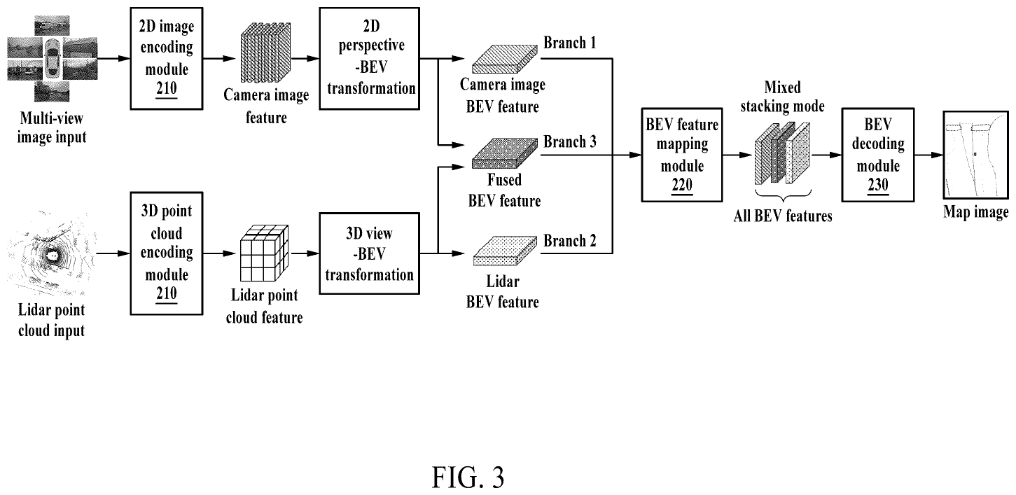

As noted, in one embodiment, the first AI network may include encoders (or an encoding modules) (e.g., a two-dimensional (2D) image encoding module 210 or a three-dimensional (3D) point cloud encoding module 212 of FIG. 2 or 3) corresponding to the respective types of data.

In a case where the first data is single-modality data including only image data collected via a camera, the electronic device may use an encoder corresponding to the camera (e.g., the 2D image encoding module 210 of FIG. 2 or 3) to extract a first feature (e.g., a camera image feature) of the image data collected via the camera.

In a case where the first data is single-modality data including only point cloud data collected via a LiDAR, the electronic device may use an encoder corresponding to the LiDAR (e.g., the 3D point cloud encoding module 212 of FIG. 2 or 3) to extract a first feature (e.g., a LiDAR point cloud feature) of the point cloud data.

In a case where the first data is multi-modality data (or mixed-modality data) including two or more types of data, the electronic device may use an encoder corresponding to each type of data to extract a second feature of each type of data. For example, in a case where the first data includes image data collected via a camera and point cloud data collected via a LIDAR, the electronic device may use an encoder (e.g., the 2D image encoding module 210 of FIG. 2 or 3) corresponding to the camera to extract a second feature from the image data, and use an encoder (e.g., the 3D point cloud encoding module 212 of FIG. 2 or 3) corresponding to the LiDAR to extract a second feature from the point cloud data. The electronic device may then fuse the second features to acquire a first feature of the first data. In this case, to fuse the second features, the electronic device may use a fusion network. The dimension of second features extracted from respective types of data of the first data and the dimension of a first feature (from fusion) may be the same.

In one embodiment, operation 102 may include operation 102-A1 to operation 102-A3.

At operation 102-A1, the electronic device may determine (or identify) a type of data included in the first data.

The electronic device may input the first data to the first AI network and acquire each type of data included in the first data using the first AI network. To acquire each type of data included in the first data, the electronic device may determine (or identify) at least one type (e.g., data type) corresponding to the first data. Each identified data type may be represented by a corresponding type indicator, collectively, “type indication information”.

The electronic device may input, to the first AI network, the first data and type indication information of the first data. The electronic device may use the first AI network to perform inference on each type of data included in the first data based on the type indication information.

At operation 102-A2, when the first data includes only one type of data, the electronic device may acquire a first feature of the first data using an encoder corresponding to the determined type, based on the first data.

At operation 102-A3, in a case where the first data includes multiple types of data, the electronic device may, for each determined type of data, extract a second feature (or, third, etc. depending on the number of types of data) using an encoder corresponding to the determined type. The electronic device may fuse the first and second features (and others as the case may be) to acquire a first feature of the first data.

In one embodiment, the first feature and the second feature described herein may each be a bird's eye view (BEV) feature.

The first AI network may be an AI network based on (or configured as) a map transformer (MapTR) network structure (e.g., an encoder-decoder-based transformer architecture). As shown in FIG. 3, an encoder (e.g., the 2D image encoding module 210 or the 3D point cloud encoding module 212) of the first AI network may be a BEV feature encoder.

An encoder (e.g., the 2D image encoding module 210) corresponding to a camera image of the first AI network may support a multi-view image as an input. The encoder corresponding to the camera image may transform a feature of the camera image into a BEV feature space, and may retain geometric information and/or semantic information of the camera image.

An encoder (e.g., the 3D point cloud encoding module 212) corresponding to LiDAR point cloud data of the first AI network may support a transformation of a LiDAR feature into the BEV feature space. The first AI network may use other encoders in addition to the encoders described above. The MapTR network is a non-limiting example.

To process a camera image, the electronic device may use an encoder corresponding to the image (an image encoder). To encode a pixel-level semantic feature of an image perspective, the electronic device may use the encoder to perform 2D-to-3D transformation. To extract a multi-view feature, the electronic device may use a ResNet50 (e.g., a residual network) as a backbone. The electronic device may use graph-based knowledge tracing (GKT) as a 2D-to-BEV feature transformation module. The electronic device may use GKT to transform a multi-view feature into the BEV feature space.

For LiDAR point cloud data, the electronic device may extract an initial feature using an encoder corresponding to the point cloud data. For example, the electronic device may use a SECOND model, voxelization, and/or sparse LiDAR encoder to process the LiDAR point cloud data. The LiDAR feature may be projected by a BEVFusion model into the BEV feature space (a flattening operation), and the LiDAR feature may thus be transformed from a 3D view into a BEV view. Through the process described above, the electronic device may acquire a unified BEV feature representation of the LiDAR point cloud data. The unified BEV feature representation may be the initial feature (e.g., BEV feature) of the LiDAR point cloud data.

In a case where the first data includes multiple types of data and fusion is therefore performed on first features; the electronic device may use a convolution-based fusion method to effectively fuse a BEV feature acquired from a camera image and a BEV feature acquired from point cloud data. For example, concatenation may be performed along a feature channel. The electronic device may then perform a convolution to fuse respective BEV features of different modalities (e.g., image data and point cloud data). Based on such a convolution operation, the electronic device may acquire the first feature (e.g., a first feature of the first data). The number of channels of the first feature may be the same as the number of channels of the second feature.

In some embodiments, operation 102 (or operation 102-A2 or operation 102-A3) of acquiring the map image based on the first feature of the first data may include operation 102-B1 and operation 102-B2.

At operation 102-B1, the electronic device may acquire, based on the first feature of the first data, a third feature corresponding to the first data. To acquire the third feature, the electronic device may enhance the first feature using a mapping network of the first AI network.

The electronic device may further map the first feature of the first data such that the mapped feature of the first data remains aligned in a feature space corresponding to each type (or each modality). The dimension of the first feature and the dimension of the third feature may be the same.

In some embodiments, the first AI network may include a first mapping network (e.g., a BEV feature mapping module 220 of FIG. 2 or 3). A weight parameter of the first mapping network may be shared, for example, between respective single types. For example, the weight of the first mapping network may be shared between two or more types in a mixed type.

The first AI network may include a second mapping network corresponding to each single type and a second mapping network (e.g., the BEV feature mapping module 220 of FIG. 2 or 3) corresponding to each in the mixed type.

Operation 102-B1 may include operation 102-B11 or operation 102-B12, depending on whether the first AI network is configured based on the first mapping network or the second mapping network.

At operation 102-B11, the electronic device may enhance the first feature of the first data to acquire the third feature corresponding to the first data. The electronic device may use the first mapping network of the first AI network to enhance the first feature of the first data.

At operation 102-B12, the electronic device may enhance the first feature of the first data to acquire the third feature corresponding to the first data. The electronic device may use the second mapping network corresponding to the first feature to enhance the first feature of the first data.

In some embodiments, at operation 102-B11, a fused BEV feature that is acquired from the BEV feature of the camera image and the BEV feature of the point cloud data and via fusion processing of the image data (e.g., the camera image) and the point cloud data may correspond to the first mapping network. Here, the first mapping network may also be referred to as a shared mapping network.

As shown in FIG. 3, the shared mapping network may be used by a BEV feature mapping module 220 (or the BEV feature mapping module 220 of FIG. 2) that performs mapping processing on a first feature (corresponding to the first data) that includes one type (e.g., data type) or on a first feature (corresponding to the first data) that includes two or more types. The shared mapping network may be a multilayer perceptron (MLP) and is represented below as “projector(⋅).” For example, the electronic device may use the shared mapping network to map the first feature from any one of three branches into a new shared feature space. For example, the first feature from one of the three branches may include, but is not limited to, a first feature of image data, a first feature of point cloud data, or a first feature corresponding to both the image data and the point cloud data. This is expressed as Equation 1 below.

$$\begin{matrix}{\hat{F}}_{Camera}^{BEV} = projector ( {F}_{Camera}^{BEV} ) , \\ {\hat{F}}_{LiDAR}^{BEV} = projector ( {F}_{LiDAR}^{BEV} ) , \\ {\hat{F}}_{Fused}^{BEV} = projector ( {F}_{Fused}^{BEV} ) ,\end{matrix} \qquad Equation 1$$

In Equation 1, projector(⋅) may be an MLP function. For example, in a case where the number “C” of feature channels is 256, the number of input feature channels of the MLP may be 256 and the number of output feature channels thereof may also be 256. The MLP may include 128 hidden layer neurons/nodes. The 128 hidden layer neurons may be shared among a BEV feature of a camera image, a BEV feature of point cloud data, and a fused BEV feature of the image data and the point cloud data. Based on this, during a training phase, the MLP may be used to further explore (or extract) an alignment knowledge between different single types and types in a mixed type from these BEV features (e.g., the BEV feature of the camera image, the BEV feature of the point cloud data, and/or the fused BEV feature). Based on the alignment knowledge, the BEV features between the different single types and the types in the mixed type may be connected (concatenated). During an inference phase, a more general or universal feature representation between the different single types and the types in the mixed type may be acquired, which may improve the network's generalization ability.

In some embodiments, at operation 102-B11, the BEV feature of the camera image, the BEV feature of the point cloud data, and the fused BEV feature including the camera image and the point cloud data may correspond to respective second mapping networks. Here, a second mapping network may also be referred to as an independent mapping network. The second mapping network may be a completely independent mapping network. For example, the second mapping networks corresponding to the BEV feature of the camera image, the BEV feature of the point cloud data, and the fused BEV feature of the camera image and the point cloud data, respectively, may be completely independent of each other. The second mapping network may be expressed as Equation 2 below.

$$\begin{matrix}{\hat{F}}_{Camera}^{BEV} = {projector}_{1} ( {F}_{Camera}^{BEV} ) , \\ {\hat{F}}_{LiDAR}^{BEV} = {projector}_{2} ( {F}_{LiDAR}^{BEV} ) , \\ {\hat{F}}_{Fused}^{BEV} = {projector}_{3} ( {F}_{Fused}^{BEV} ) ,\end{matrix} \qquad Equation 2$$

In Equation 2, projector₁(⋅), projector₂(⋅), and projector₃(⋅) are mapping networks corresponding to the BEV feature of the camera image, a mapping network corresponding to the BEV feature of the point cloud data, and a mapping network corresponding to the fused BEV feature, respectively. For example, these may be MLP functions corresponding to the respective independent mapping networks.

The electronic device may acquire a map image (e.g., a high-definition (HD) map) corresponding to the first data using a decoder (e.g., a BEV feature decoder 230 of FIG. 2 or a BEV decoding module 230 of FIG. 3) of the first AI network, based on the first feature corresponding to the first data.

When the first mapping network is used, the electronic device may acquire the map image corresponding to the first data using the decoder of the first AI network, based on the third feature and the first feature corresponding to the first data.

For example, as a mapping network, a residual connection-based shared mapping network may be used. The BEV feature of the camera image, the BEV feature of the point cloud data, and the fused BEV feature of the camera image and the point cloud data may correspond to the first mapping network. The first mapping network may be shared among the BEV feature of the camera image, the BEV feature of the point cloud data, and the fused BEV feature. The first mapping network may be the residual connection-based shared mapping network (e.g., a skip shared projector). For example, the first feature (or input first feature) may be directly connected to an output based on a skip connection (or residual connection). The skip connection may allow the first feature to “skip” at least one layer (e.g., an intermediate layer). In one embodiment, the residual connection-based mapping network may be implemented via an addition operation. For example, the residual connection-based mapping network may be implemented by adding an input and an output together. The residual connection-based mapping network may be implemented as expressed by Equation 3 below.

$$\begin{matrix}{\hat{F}}_{Camera}^{BEV} = projector ( {F}_{Camera}^{BEV} ) + {F}_{Camera}^{BEV} , \\ {\hat{F}}_{LiDAR}^{BEV} = projector ( {F}_{LiDAR}^{BEV} ) + {F}_{LiDAR}^{BEV} , \\ {\hat{F}}_{Fused}^{BEV} = projector ( {F}_{Fused}^{BEV} ) + {F}_{Fused}^{BEV} ,\end{matrix} \qquad Equation 3$$

In Equation 3, projector(⋅) may represent a linear perceptron function (e.g., a two-layer linear perceptron function). The BEV feature of the camera image, the BEV feature of the point cloud data, and the fused BEV feature including the camera image data and the point cloud data may share network parameters of a skip projector module (e.g., a residual connection-based mapping network module).

In one embodiment, the second mapping network may also use a residual connection-based mapping network. When the second mapping network is used, the electronic device may acquire the map image of the first data, based on the third feature and the second feature corresponding to the first data, using the decoder (e.g., the BEV feature decoder 230 of FIG. 2) of the first AI network. The implementation based on the second mapping network is substantially the same as the implementation of the residual connection-based shared mapping network described above, e.g., the first mapping network.

At operation 102-B2, the electronic device may acquire/generate the map image corresponding to the first data using the decoder of the first AI network, based on the third feature corresponding to the first data. The map image may be an HD map output from the decoder. The HD map may be a map image corresponding to vectorized (or comprised of) map elements. For example, map elements may include, but are not limited to, a road boundary, a lane divider, and/or a pedestrian crossing. In the HD map, different colors may be used to distinguish different map elements.

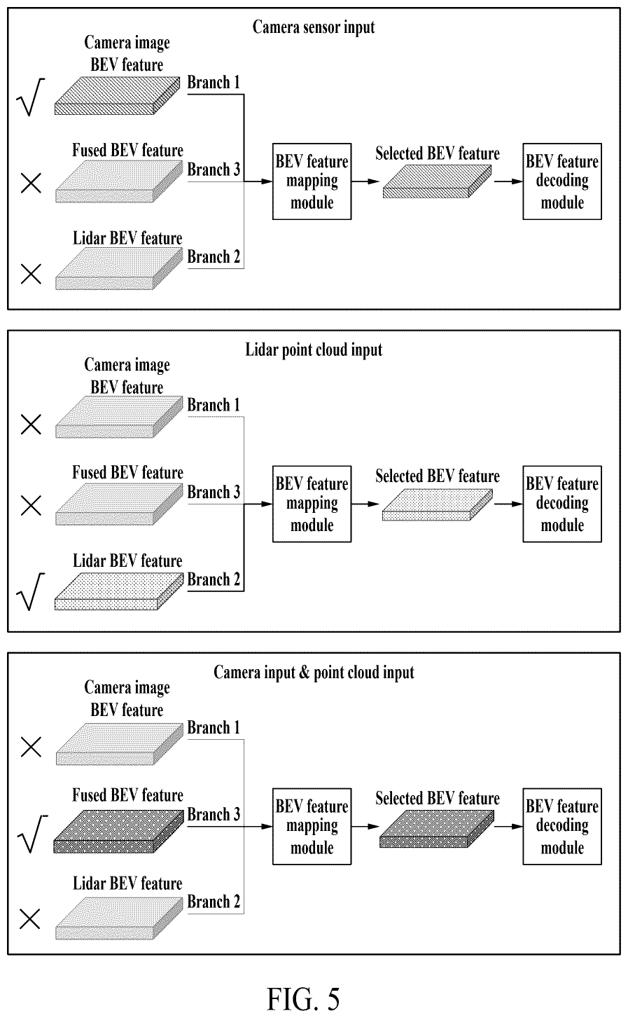

In some embodiments, a modality-switching strategy may be used to better address missing or malfunctioning (damage) of sensors, adapt seamlessly to any modality inputs, and ensure compatibility between different modality inputs. As shown in FIG. 5, in the inference phase, a trained first AI network may support the use of any modality/modalities input and perform an accurate prediction. The modality-switching strategy may implemented as expressed by Equation 4.

$${\hat{F}}_{Select}^{BEV} \{ \begin{matrix}{\hat{F}}_{Camera}^{BEV} , & only camera sensor input \\ {\hat{F}}_{LiDAR}^{BEV} , & only Lidar sensor input \\ {\hat{F}}_{Fused}^{BEV} , & both camera and LiDAR sensor input\end{matrix} \qquad Equation 4$$

The modality-switching strategy may simulate a real situation of a missing sensor in the inference phase.

In one embodiment, when only a camera sensor input is available, such as, for example, when point cloud data is insufficient or when point cloud data is unavailable due to uninstallation of a LIDAR or a broken (or damaged) LiDAR, a camera BEV feature

$${\hat{F}}_{Camera}^{BEV}$$

may be selected as an input to a BEV decoder (e.g., the BEV feature decoder 230 of FIG. 2 or the BEV decoding module 230 of FIG. 3).

In one embodiment, when there is no camera sensor or when only point cloud input is available, a LIDAR feature

$${\hat{F}}_{LiDAR}^{BEV}$$

may be selected as an input to a map decoder (e.g., the BEV decoder).

In one embodiment, when both camera input and point cloud input are available, a mixed BEV feature (or a fused BEV feature)

$${\hat{F}}_{Fused}^{BEV}$$

may be selected as an input to the map decoder.

By supporting various modalities of data input, the trained first AI network may generate an accurate HD map in spite of changes in the modality of data input. The HD map may improve the autonomous driving performance of a vehicle, improve the quality of a displayed BEV image/map, etc.

The method provided in the present disclosure may begin with acquiring first data. The first data may include at least one type of data. Based on the first data, the method may generate a map image corresponding to the first data using a first AI network. In a case where the first data includes only one type of data (e.g., single modality), the method may acquire a first feature of the first data using an encoder corresponding to that type. Based on the first feature, the method may generate the map image. In a case where the first data includes two or more types of data (e.g., multi-modal), the method may extract a second feature based on each type of data using an encoder corresponding to each type of data. The method may fuse the respective second features to acquire a first feature of the first data. Based on the first feature (by whichever means), the method may generate the map image. In this way, the first AI network may handle both prediction scenarios: a prediction scenario based on a single type of data and a prediction scenario based on a mixed type of data (or hybrid data). The first AI network may perform a prediction highly accurately and may thus improve the robustness of the network.

FIG. 1B illustrates an example of operations performed by an electronic device according to one or more example embodiments.

Referring to FIG. 1B, an electronic device (e.g., an electronic device 4000 of FIG. 8) may be a server, a cloud computing center device, or a terminal.

At operation 201, the electronic device may acquire a training data set. The training data set may include first samples and second samples related to the first samples. A type (or modality) of the first samples and a type (or modality) of the second samples may be different. Here, a sample is analogous to an input data mentioned above, albeit acquired differently and used for training rather than real-time inference.

Each first sample may include sample data of a first type, and each second sample may include sample data of a second type. Labels of the first samples and labels of the second samples may be real map images corresponding to corresponding sample data.

The training data set may include at least two types of samples. For example, the training data set may include first samples of a first type, second samples of a second type, and third samples of a third type. For example, in a case where an autonomous driving system includes a camera, a LIDAR, and a mmWave radar, three data types may be provided. The types of samples included in the training data set may be configured as needed.

A type of data (or data type) may also be referred to as a modality of the data. A first sample and a second sample may each be a different single-modality sample data including only one modality.

In some embodiments, an HD map construction method may play an important role in providing static environmental data required for an autonomous driving system. The HD map construction method may use at least one of various sensors (e.g., a camera and a LIDAR) to collect data. Using the collected data, the HD map construction method may construct a map. In this case, respective pieces of data collected from different sensors may be treated as data of different modalities. For example, a modality of data collected via a camera may be different from a modality of data collected via a LIDAR.

In some embodiments, after acquiring the training sample data, the first AI network may be trained based on a first sample of a single modality and a second sample of a single modality. The first AI network may be trained to process data of various single types (e.g., various signal modalities) and a mixed modality (e.g., a mixed type including various single types or two or more types, possibly multiple mixed modalities when there are more than two modalities). The first AI network trained based on a training method described herein according to embodiments of the present disclosure may have high robustness and high generalization ability. In one example, the trained first AI network may assist in constructing a map using both image data from a camera and point cloud data from a LiDAR. In another example, the trained first AI network may assist in constructing a map using any of the image data from the camera and the point cloud data from the LiDAR.

The trained first AI network may have a desirable performance for an arbitrary modality of data. Thus, a unified robust HD map construction network (Uni-Map) may be achieved.

The first samples may be of a first type of data. For each first sample, there may be a second sample related thereto. The label of each first sample and the label of its related second sample may be the same.

Although two modalities (e.g., a first modality and a second modality) are described herein, examples are not limited thereto. For example, a first sample may have a second sample related to the first sample and a third sample related to the first sample.

The first samples may include vehicle environment images acquired at different driving moments (or time points) collected via a camera, and the second samples may be vehicle environment point cloud data acquired at different driving moments collected via a LIDAR. At the same driving point, camera image data and point cloud data may be correlated. In this case, the label of a first sample and the label of a second sample related to the first sample may be the same. In this case, the label of the first sample and the label of the second sample may each be a real map image (e.g., a BEV map image) of an environment around a vehicle at the corresponding driving point (or moment).

For example, in an autonomous driving scenario, data of various modalities may be collected at different time points while a vehicle is traveling. For example, while the vehicle is traveling, an image of the environment around the vehicle may be collected via a camera at a time “T1” and point cloud data of the environment around the vehicle may also be collected via a LiDAR at the same time “T1.” The data of different modalities (e.g., the image data and the point cloud data) collected at the same driving time point (e.g., the time “T1”) may be correlated (linked, associated, etc.).

At operation 202, the electronic device may acquire a fourth feature of each first sample, a fifth feature of each second sample, and a sixth feature of each first sample and each second sample (e.g., each second sample related to each first sample), using a second AI network, based on the training data set.

For the first samples, the electronic device may acquire the fourth feature of a corresponding first sample using an encoder corresponding to a type of the first sample. For the second samples, the electronic device may acquire the fifth feature of a corresponding second sample using an encoder corresponding to a type of the second sample. The electronic device may fuse the fourth feature and the corresponding fifth feature to acquire the sixth feature of the first sample and its related second sample.

For example, the second AI network may include encoders configured to encode for different respective types (e.g., data types or data modalities).

The electronic device may use an encoder corresponding to a type of each sample to acquire an initial feature of each sample. For example, the electronic device may acquire the fourth feature by using an encoder corresponding to a type of the first sample, and the fifth feature by using an encoder corresponding to a type of the second sample.

For example, the second AI network may include an encoder corresponding to the first type and an encoder corresponding to the second type. The electronic device may use the encoder corresponding to the first type to extract an initial feature of the first sample and use the encoder corresponding to the second type to extract an initial feature of the second sample. To acquire the sixth feature of the first sample and the second sample related to the first sample, the electronic device may use a fusion network to fuse the initial feature of the first sample (e.g., the fourth feature) and the initial feature of the second sample (e.g., the fifth feature). The dimension of the initial feature of the first sample, the dimension of the initial feature of the second sample, and the dimension of the sixth feature may be the same.

The electronic device may predict a vectorized map element in a BEV space from data χ (e.g., sensor data) of any of the potential modalities, as they arise. In this case, map element classes may include, but are not limited to, a road boundary, a lane divider, and/or a pedestrian crossing. As shown in FIG. 2 and FIG. 3, data of an input modality may be expressed as Equation 5.

$$χ = \{ Camera , LiDAR \} \qquad Equation 5$$

In Equation 5, Camera denotes image data collected via a camera, and LiDAR denotes point cloud data collected via a LIDAR sensor. The image data may include a multi-view red, green, blue (RGB) camera image in an image perspective (or perspective view). For example, the image data may include six images captured from different directions, such as, the front, back, and sides of a vehicle. For example, the image data may be expressed as Equation 6 below.

$$Camera ∈ {R}^{B \times {N}^{c a m} \times {H}^{c a m} \times {W}^{c a m} \times 3} \qquad Equation 6$$

In Equation 6, B denotes a batch size, Ncam denotes the number of cameras, Hcam denotes an image height, and Wcam denotes an image width. For example, the number of cameras may be 6, and the batch size may be the number of samples used in one iteration of training.

For example, the point cloud data may be expressed as Equation 7 below.

$$LiDAR ∈ {R}^{B \times P \times 5} \qquad Equation 7$$

In Equation 7, B denotes a batch size, P denotes the number of points, where data of each point may include a 3D coordinate, a reflectivity, and/or a ring index of a corresponding point. The ring index may be optionally included. If the ring index is not included, a last dimension “5” in Equation 7 may be changed to “4.”

The second AI network may be an AI network based on a map transformer (MapTR) network structure (e.g., an encoder-decoder based transformer architecture). As shown in FIG. 2 and FIG. 3, an encoder of the second AI network may be a BEV feature encoder. An encoder of the second AI network corresponding to a camera image may receive a multi-view image as an input. The encoder of the second AI network corresponding to the camera image may transform a feature of the camera image into a BEV feature while retaining geometric and/or semantic information.

An encoder of the second AI network corresponding to LiDAR point cloud data may support transforming a LiDAR feature into a BEV feature space. In addition to the encoders described herein, other encoders may also be used for the second AI network. In the present disclosure, MapTR is a non-limiting descriptive example.

For the camera image, the encoder corresponding to the image may be used. For example, the 2D image encoding module 210 of FIG. 2 may perform a 2D-to-3D transformation to encode a pixel-level semantic feature in an image perspective (or perspective view). To extract a multi-view feature, ResNet50 may be used as a backbone. To transform the multi-view feature into the BEV space, GKT may be used as a 2D-to-BEV feature transformation module. The generated BEV feature may be expressed as Equation 8 below.

$${F}_{Camera}^{BEV} ∈ {R}^{B \times H \times W \times C} \qquad Equation 8$$

In Equation 8, B, H, W, and C denote a batch size, an image height, an image width, and the number of feature channels, respectively.

In one embodiment, BEV feature modelling may be performed using lift, splat, shoot (LSS) to explicitly estimate depth information of an image, extract a collected feature of the image, and transform the image feature into a BEV feature based on the estimated discrete depth information. For example, a perspective feature

$${F}_{Camera}^{PV}$$

may be extracted from an image Camera∈R^{B×N}^{^{cam}}^{×H}^{^{cam}}^{×W}^{^{cam}}^{×3} corresponding to each direction via 2D convolution, and a depth distribution of D (e.g., 256 or 512) discrete points associated with pixels in the image may be predicted. The pixels and the discrete points may respectively correspond to each other. Subsequently, to acquire a pseudo point cloud feature

$${F}_{Camera}^{3 D}$$

of D×H×W, the perspective feature

$${F}_{Camera}^{PV}$$

may be assigned to the U discrete points along a camera's line of sight. The pseudo point cloud feature

$${F}_{Camera}^{3 D}$$

may be flattened into the BEV feature space via a pooling operation. Based on a 2D perspective view-to-BEV view transformation through flattening, an initial feature (e.g., a BEV feature) of the image may be acquired. The initial feature may be expressed as Equation 9 below.

$${F}_{Camera}^{BEV} ∈ {R}^{B \times H \times W \times C} \qquad Equation 9$$

In Equation 9, C may be, but is not limited to, 512 or 256.

For LiDAR point cloud data, an encoder corresponding to the point cloud data may be used to extract an initial feature. For example, a 3D point cloud encoding module may be used, and it may be based on a SECOND model. For example, a voxelization and/or LiDAR encoder may also be used. A LIDAR feature may be projected from (or by) a BEVFusion model into the BEV feature space based on a flattening operation, and the LiDAR feature may be transformed from a 3D view into a BEV view. Through this process, a unified BEV feature representation of the LiDAR point cloud data may be acquired. The unified BEV feature representation may be an initial feature (e.g., a BEV feature) of the LiDAR point cloud data.

For a camera image and point cloud data that are associated with each other, feature fusion may be performed to acquire a fused BEV feature corresponding to the camera image and the point cloud data. To effectively fuse a BEV feature of the image with a BEV feature of the LiDAR point cloud data, a convolution-based fusion method may be used. For example, concatenation may be performed along feature channels. Subsequently, the BEV feature of the image and the BEV feature of the point cloud data may be fused together via convolution. For example, a BEV feature

$${F}_{Camera}^{BEV}$$

∈R^{B×H×W×C} of the image and a BEV feature

$${F}_{LiDAR}^{BEV}$$

∈R^{B×H×W×C} of the point cloud data may be fused together along a C-channel dimension to acquire a fused feature

$${F}_{Fused}^{BEV}$$

∈R^{B×H×W×C}. Here, the number of channels of the BEV feature of the image, the number of channels of the BEV feature of the point cloud data, and the number of channels of the fused feature may be equal to each other.

At operation 203, the electronic device may perform a prediction using the second AI network, based on the fourth feature of the first sample, the fifth feature of the second sample, and the sixth feature of the first sample and the second sample related to the first sample, to acquire a prediction result corresponding to both related samples.

The prediction result corresponding to both/all related samples may include a first image corresponding to the first sample, a second image corresponding to the second sample, and a third image corresponding to the first sample and its related second sample.

In some embodiments, operation 203 may include operation 203-1 and operation 203-2.

At operation 203-1, the electronic device may enhance the fourth feature, the fifth feature, and the sixth feature using a first mapping network of the second AI network, based on the fourth feature of each first sample, the fifth feature of each second sample, and the sixth feature of each first sample and its related second sample. The electronic device may further map the fourth feature, the fifth feature, and the sixth feature such that a mapped feature of each sample remains aligned in the feature space.

Regarding the just-mentioned mapping, a mapping process may be performed via a mapping network. The mapping network may be a shared mapping network or an independent mapping network. In one example, the second AI network may include a first mapping network to be trained. The first mapping network may be shared among different single types or types of a mixed type. In another example, the second AI network may include at least one second mapping network to be trained. The second AI network may include respective second mapping networks corresponding to the single types or the types of the mixed type, respectively.

Depending on whether the second AI network includes the first mapping network or the second mapping network, the electronic device may perform operation 203-1. In a case where the second AI network includes the first mapping network, the electronic device may enhance the fourth feature, the fifth feature, and the sixth feature, using the first mapping network to be trained, based on the fourth feature, the fifth feature, and the sixth feature. The electronic device may acquire the enhanced fourth feature, the enhanced fifth feature, and the enhanced sixth feature via an enhancement process. In a case where the second AI network includes the second mapping network, the electronic device may separately enhance the fourth feature, the fifth feature, and the sixth feature using a corresponding second mapping network to be trained, based on the fourth feature, the fifth feature, and the sixth feature. The electronic device may acquire the enhanced fourth feature, the enhanced fifth feature, and the enhanced sixth feature, via the enhancement process.

In some embodiments, the first mapping network may be a shared mapping network. Here, samples may correspond to the same network parameters of the shared mapping network. For example, training samples may correspond to one shared mapping network. This may indicate that different single-modality sample data or mixed-modality sample data share weight parameters within the shared mapping network.

For example, as shown in FIG. 3, the shared mapping network may be a BEV feature mapping module used in the first AI network to map an initial feature. For example, the shared mapping network may be an MLP and may be represented as “projector(⋅).” For example, the electronic device may use a learnable shared mapping network to map an initial feature of an image, an initial feature of point cloud, and an initial feature of a mixed modality from three branches into a new shared feature space. This may be expressed as Equation 10 below.

$${\hat{F}}_{Camera}^{BEV} = projector ( {F}_{Camera}^{BEV} ) , \qquad Equation 10$$

$${\hat{F}}_{LiDAR}^{BEV} = projector ( {F}_{LiDAR}^{BEV} ) ,$$

$${\hat{F}}_{Fused}^{BEV} = projector ( {F}_{Fused}^{BEV} ) ,$$

In Equation 10, projector(⋅) may denote an MLP function. For example, in a case where the number of feature channels is 256, the number of input feature channels of the MLP may be 256, and the number of output feature channels may also be 256. The MLP may include 128 hidden layer neurons, and the network parameters of the hidden layer neurons may be shared among a BEV feature of an image, a BEV feature of point cloud data, and a BEV feature of mixed modality data (e.g., mixed data of the image and the point cloud data). Based on this, the MLP may concatenate different single-modality BEV features and/or mixed-modality BEV features. In this way, alignment knowledge (information that can enable alignment) between different single-modality and/or mixed-modality sources may be further extracted, which may enable learning more general and universal feature representations between various modalities and improve the network's generalization ability.

At operation 202, BEV features corresponding to the same BEV feature space may be acquired for different single modalities and/or modalities of a mixed modality. However, within a view transformer, spatial misalignment may still exist between a BEV feature of an image, a BEV feature of point cloud data, and a BEV feature of mixed-modality data, due to inaccuracies in depth estimation and/or large gaps between the modalities. For example, BEV features of different single-modality data and BEV features of mixed-modality data may each be located in a completely independent region in the BEV feature space.

In one embodiment, as shown in FIG. 3, a mixture stack modality (MSM) training method may enhance semantic consistency between BEV features of different single modalities and modalities of a mixed modality, via a BEV feature mapping module. It may be used to realize more robust alignment and acquire a feature representation with a more robust generalization ability.

In one embodiment, a mapping network (e.g., a partially shared projector) that is partially shared among samples may be used. In this case, a key difference between the partially shared projector and a fully shared projector may be that, in the partially shared projector (or partially shared mapping network), a first linear layer is not shared. The first linear layer of the partially shared projector may learn knowledge from different single-modality and multi-modality sources (e.g., data) independently, while a second linear layer may learn knowledge about multiple modalities together (or jointly). For example, each of these three modalities—a first modality, a second modality, and a mixed modality—may have its own network parameters in the first linear layer and may share the network parameters in the second linear layer.

Different single modalities and mixed modalities may correspond to different mapping networks. For example, based on an initial feature of each training sample and a modality of each training sample, a target feature of each training sample may be determined using a mapping network corresponding to a modality of each training sample in the first AI network.

Each modality may correspond to its own independent mapping network (e.g., independent projector). For example, different modalities of first sample data may correspond to different mapping networks, and different modalities of a mixed modality of second sample data may also correspond to different mapping networks. The processing of an independent mapping network may be as expressed by Equation 11.

$${\hat{F}}_{Camera}^{BEV} = {projector}_{1} ( {F}_{Camera}^{BEV} ) , \qquad Equation 11$$

$${\hat{F}}_{LiDAR}^{BEV} = {projector}_{2} ( {F}_{LiDAR}^{BEV} ) ,$$

$${\hat{F}}_{Fused}^{BEV} = {projector}_{3} ( {F}_{Fused}^{BEV} ) ,$$

In Equation 11, projector₁(⋅), projector₂(⋅), and projector₃(⋅) denote a mapping network corresponding to a BEV feature of a first sample, a mapping network corresponding to a BEV feature of a second sample, and a mapping network corresponding to a fused BEV feature of the first sample and the second sample related to the first sample, respectively. For example, the mapping networks may be MLP functions corresponding to independent mapping networks.

Using the mapping networks corresponding to the BEV feature of the first sample, the BEV feature of the second sample, and the fused BEV feature, feature enhancement may be performed separately. Based on this, iterative training may enhance semantic consistency between different single-modality and mixed-modality BEV features. The iterative training may be performed to acquire a feature representation with a robust generalization ability.

In one embodiment, a residual connection-based shared mapping network (e.g., a skip shared projector) may be used between different single modalities and modalities of a mixed modality. For example, a skip connection (or residual connection) may connect initial features of respective modalities directly to outputs. The skip connection may allow initial features to be transferred between different layers. The residual connection-based shared mapping network may be implemented via an addition operation. For example, the residual connection-based shared mapping network may be implemented by adding inputs and outputs to each other. The residual connection-based shared mapping network may be expressed as Equation 12 below.

$${\hat{F}}_{Camera}^{BEV} = projector ( {F}_{Camera}^{BEV} ) + {F}_{Camera}^{BEV} , \qquad Equation 12$$

$${\hat{F}}_{LiDAR}^{BEV} = projector ( {F}_{LiDAR}^{BEV} ) + {F}_{LiDAR}^{BEV} ,$$

$${\hat{F}}_{Fused}^{BEV} = projector ( {F}_{Fused}^{BEV} ) + {F}_{Fused}^{BEV}$$

In Equation 12, projector(⋅) may include a linear perceptron function (e.g., a two-layer linear perceptron function). Different single-modality and mixed-modality BEV features may share a skip projector module (e.g., a residual connection-based mapping network module). For example, the network parameters of the skip projector module may be shared between different training samples.

At operation 203-2, the electronic device may acquire a prediction result corresponding to each sample using a decoder of the second AI network, based on the enhanced fourth feature, the enhanced fifth feature, and the enhanced sixth feature.

The decoder may be shared among a plurality of samples (e.g., all samples), meaning the network parameters of the decoder may be shared between single-modality sample data and multi-modality sample data.

As shown in FIG. 2 and FIG. 3, a predicted image may be a map image (e.g., an HD image) output from the decoder. The HD map may be a map image corresponding to (or comprised of) vectorized map elements. For example, map element classes may include, but are not limited to, a road boundary, a lane divider, and/or a pedestrian crossing. In the HD map, different colors may be used to distinguish different map elements.

Based on this, the decoder may learn different single-modality and mixed-modality knowledge. This may improve the robustness of the network when predicting scenarios of arbitrary modalities.

At operation 204, the electronic device may train the second AI network based on the prediction result corresponding to each sample (e.g., a training sample) of the training data set to acquire the first AI network.

The electronic device may divide the samples (e.g., training samples) into multiple groups of related samples. The electronic device may perform iterative training based on a training loss corresponding to each group of related samples.

In some embodiments, operation 204 may include operation 204-1 and operation 204-2.

At operation 204-1, the electronic device may determine a training loss for each group of related samples based on a sample label corresponding to at least one group of related samples and based on a prediction result. A prediction result for one group of related samples may include a first image corresponding to a first sample, a second image corresponding to a second sample related to the first sample, and a third image corresponding to both the first sample and the second sample related to the first sample.

For example, a process may be described using a first modality and a second modality. Each group of related samples may include a first sample and a second sample related to the first sample. For example, a group of related samples may include images collected at the same time point (e.g., six images collected at the same time point) and point cloud data collected from a LIDAR.

For each group of related samples, a training loss of each predicted image (e.g., the first image, the second image, or the third image) may be calculated by a loss function of the MapTR model. The loss function may include three parts: a classification loss L_{cis}, a point-to-point loss Lₚ₂ₚ, and a directional edge loss L_{dir}. A loss corresponding to each predicted image may be calculated as expressed in Equation 13 below.

$$ℒ = {λ}_{1} {ℒ}_{cls} + {λ}_{2} {ℒ}_{p 2 p} + {λ}_{3} {ℒ}_{dir} \qquad Equation 13$$

In Equation 13, [symbol] denotes a loss corresponding to a predicted image, and λ₁, λ₂, and λ₃ may be hyper-parameters for balancing loss components. For example, in the training phase, λ₁ may be set to 2, λ₂ may be set to 5, and λ₃ may be set to 5e⁻³.

For each group of related samples, a training loss corresponding to each group may be calculated as expressed in Equation 14 below.

$$ℒ = {λ}_{4} {ℒ}_{1} + {λ}_{5} {ℒ}_{2} + {λ}_{6} {ℒ}_{3} \qquad Equation 14$$

In Equation 14, [symbol] denotes a training loss corresponding to a group of related samples, and [symbol] and [symbol] denote a loss (e.g., a prediction loss) corresponding to the first image, a loss corresponding to the second image, and a loss corresponding to the third image, respectively. λ₄, λ₅ may, and λ₆ denote coefficients for the respective corresponding losses. For example, λ₄, λ₅, and λ₆ may each be set to 1. This may indicate that an average of losses for predicted images (e.g., the first image, the second image, and the third image) in a group of related samples is used as a training loss for that group.

Based on this, the first AI network may learn information from different single-modality and mixed-modality samples, and the first AI network may have high accuracy in prediction scenarios for any modality in different single modalities and a mixed modality. This may increase the robustness of the AI network.

At operation 204-2, the electronic device may train the second AI network based on the training loss corresponding to each group of related samples.

The electronic device may adjust parameters of each network of the second AI network based on the training loss corresponding to each group of related samples. For example, parameters of each of an encoder, a mapping network, and a decoder corresponding to each modality may be adjusted. However, examples are not limited thereto. For example, parameters of a network may be updated using a stochastic gradient descent (SGD) algorithm and/or a chain rule.

In a typical HD map construction method according to the related art, a decoder may only learn a BEV feature of one modality. Such a typical learning scheme may limit an input configuration of the decoder to a single modality.

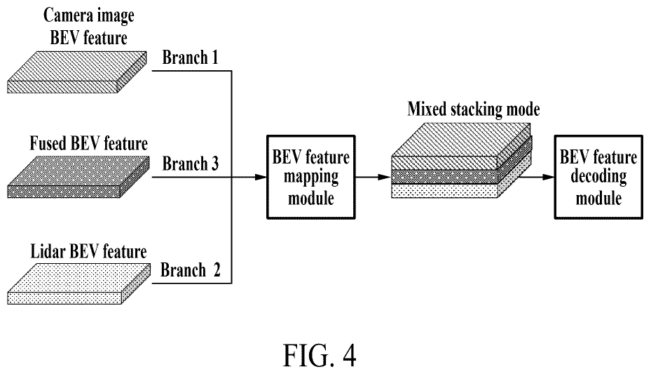

As described herein, to ensure that the trained first AI network has high accuracy in prediction scenarios for arbitrary modalities, the decoder may be designed to be suitable for a new mixed-stacking modality training scheme. As shown in FIG. 4, different single-modality and mixed-modality samples may share the network parameters of the decoder, allowing the trained network to learn rich knowledge about different single-modality and mixed-modality inputs. For example, a BEV feature of a camera image, a BEV feature of a LIDAR, and a BEV feature of a mixed modality may be input to the decoder in the form of a mixed-stacking modality for mixed-stacking learning (e.g., joint learning). For example, a process for the mixed-stacking learning may be expressed as in Equation 15 below.

$${\hat{F}}_{Stack}^{BEV} = Stack ( {\hat{F}}_{Camera}^{BEV} , {\hat{F}}_{LiDAR}^{BEV} , {\hat{F}}_{Fused}^{BEV} ) \qquad Equation 15$$

In Equation 15, a stacked BEV feature

$${\hat{F}}_{Stack}^{BEV}$$

represents a feature learned from a BEV feature of a camera image, a BEV feature of a LIDAR (or point cloud data), or a BEV feature of a mixed modality. The stacked BEV feature

$${\hat{F}}_{Stack}^{BEV}$$

may be used to train the decoder for constructing an HD map.

The stacking process described above may be performed in a batch dimension. After the stacking process, the shape of a feature map may still be H×W×D, and thus a subsequent map decoder module may be directly applied to an existing network such as MapTR. Based on this, the method of embodiments of the present disclosure may be a plug-and-play technique. Such a mixed-stacking strategy may allow the map decoder module to learn rich knowledge from the features of a camera, a LIDAR, or a mixed modality. This may also improve the robustness of the AI network. The AI network trained based on the method of embodiments of the present disclosure may be used for prediction scenarios for arbitrary modalities.

The unified map approach described herein is a novel unified robust HD map construction network. After training, this network may be an all-in-one model that operates under input configurations of arbitrary modalities. To this end, in the training phase, the decoder may receive features of all input configurations including a single modality and a mixed modality. In the inference phase, the decoder may process a specific feature based on an input configuration of a deployed modality.

As shown in FIGS. 2 and 3, given different perception inputs, an encoder for each modality may be used to extract features of each modality. Various single-modality and mixed-modality features may be transformed into a unified BEV feature, which may retain geometric and semantic information.

Subsequently, a novel mixed-stacking modality training scheme may be used. In this training scheme, the decoder may acquire rich knowledge from a fused feature of a camera, a LIDAR, or a combination of both modalities. To align, in a shared feature space, BEV features from different single modalities and modalities in a mixed modality, a mapping network may be used. The mapping network may be used to improve representation learning and overall model performance. Lastly, a mixed-stacking BEV feature may be input to a detector and a prediction head to construct an HD map. In the inference phase, the electronic device may perform an accurate prediction using Uni-Map, based on the modality-switching strategy, when provided with an input of any modality.

According to an embodiment of the present disclosure, a method may include acquiring a training data set. The training data set may include first samples and second samples related to the first samples. A data type of the first samples may be different from a data type of the second samples. Based on the training data set, a second AI network may acquire a fourth feature of each first sample, a fifth feature of each second sample, and a sixth feature of each first sample and each second sample related to each first sample to generate a prediction result corresponding to each sample in the training data set. The second AI network may perform a prediction based on the fourth feature, the fifth feature, and the sixth feature. The prediction result may include a first image corresponding to each first sample, a second image corresponding to each second sample, and a third image corresponding to each first sample and each second sample related to each first sample. The second AI network may be trained based on the prediction result corresponding to each sample in the training data set to acquire a first AI network. The first AI network may learn knowledge from different single-modality and mixed-modality sample data, may have high prediction accuracy for prediction scenarios for arbitrary modalities and may have high network robustness.

A camera and a LIDAR may be primary sensors mainly used for map construction, and an input configuration may vary based on considerations of cost and/or performance. For example, the input configuration may include only one of a camera image input and a LIDAR input, or may include a camera image-LiDAR fused input. In general, a camera image-LiDAR fusion-based method may perform best. Previous map construction methods typically experience the following technical challenges.

A prior method may require training and/or deploying models separately for input configurations. This may incur great costs for development, maintenance, and/or deployment (e.g., in a large fleet of vehicles).

The typical prior method is designed under the assumption that the models always have access to complete information from both sensors (e.g., a camera and a LiDAR). This reduces the robustness of prior models in the event of a missing sensor or a damaged sensor. For example, if a camera is unavailable, only LiDAR point cloud data may be used as an input. The damaged sensor may be one that is partially damaged or corrupted. For example, if one of six camera images is damaged, the remaining five camera images and LiDAR point cloud data may be used as an input.

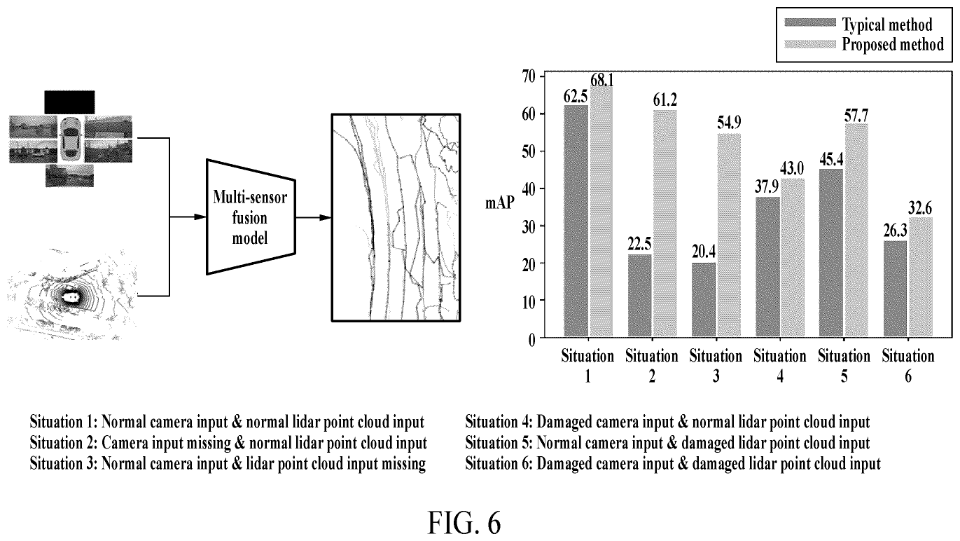

An influence of multi-sensor damage on a camera image-LiDAR fusion model may be identified via the scenarios shown in FIG. 6 and the evaluation indices corresponding to the scenarios. For example, a mean average precision (mAP) may be used as an index of evaluation. In the typical method of related art, a missing or damaged sensor (e.g., a damaged camera and/or LiDAR) may significantly degrade the performance of the camera image-LiDAR fusion model.

With the unified mapping techniques described herein, a unified robust HD construction network may be a single model that exhibits a desirable performance for all input configurations, even as they change during use. For example, a novel mixed-stacking modality training scheme (e.g., MSM) is proposed herein. The mixed-stacking modality training scheme may enable a map decoder to effectively learn feature information from a camera, a LIDAR, and a mixed modality. In addition, this disclosure proposes a mapping module that aligns various single-modality and mixed-modality BEV features into a shared feature space. The mapping module may enhance feature representations and improve the overall model performance. In one embodiment, in the inference phase, the modality-switching strategy may be used. The modality-switching strategy may allow the network to adapt seamlessly to arbitrary modality inputs. This may improve compatibility with different input configurations. The unified mapping model may have high performance under different input configurations and may reduce the training cost and deployment cost of the model.

FIG. 6 shows a result of comparing a performance of the methods and models described herein with performance of the typical prior method. As shown in FIG. 6, the proposed method may exhibit more robust performance than the typical method under a normal situation and also in conditions of missing or damaged sensors. The proposed method may reduce the performance degradation in the case of missing or damaged sensors, and may have better performance and higher robustness than the typical method in various scenarios. Further, a mixed-stacking modality training method (MSM), a mapping module, and/or a modality-switching strategy, which are the core components of Uni-Map, may be simple and effective plug-and-play techniques. They may be compatible with various existing perception task pipelines.

The structure of the first AI network may be implemented using Pytorch which is a deep learning framework. An implementation of the first AI network was tested using an nuScenes data set.

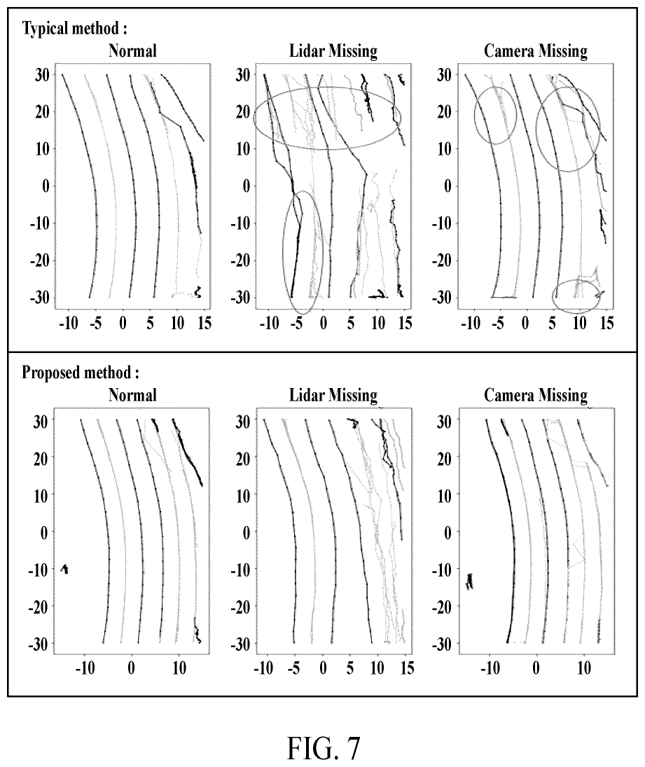

FIG. 7 shows HD maps generated by the proposed method described herein and the typical method of related art, under a normal situation, in a case where point cloud data is missing, and in a case where a camera image is missing. As shown in FIG. 7, the accuracy of an HD map generated by the proposed method may be relatively high, while an HD map generated by the typical prior method may have a number of anomalies. The proposed method may exhibit high performance for all input configurations (e.g., when there is only a camera image input, when there is only a LiDAR input, and when there is only a camera-LiDAR fused input).

In one embodiment, the electronic device may include a processor and may optionally include a transceiver and/or memory connected to the processor. The processor may be configured to execute operations of the methods provided according to various example embodiments of the present disclosure.

FIG. 8 schematically illustrates an example of an electronic device according to one or more example embodiments. As shown in FIG. 8, an electronic device 4000 may include at least one processor 4001 and a memory 4003.

The at least one processor 4001 and the memory 4003 may be connected to each other. For example, the at least one processor 4001 and the memory 4003 may be connected to each other via a bus 4002. The electronic device 4000 may further include a transceiver 4004. The transceiver 4004 may be used for data exchange, such as, data transmission and/or data reception between the electronic device 4000 and another electronic device (not shown). It should be noted that, in practical applications, the transceiver 4004 is not limited to one, and the structure of the electronic device 4000 does not constitute a limitation to the embodiments of the present disclosure. Optionally, the electronic device 4000 may be a first network node, a second network node, or a third network node.

The at least one processor 4001 may be, as non-limiting examples, a central processing unit (CPU), a general-purpose processor, a digital signal processor (DSP), an application-specific integrated circuit (ASIC), a field-programmable gate array (FPGA) or any other programmable logic device, a transistor logic device, a hardware component, or any combination thereof. The at least one processor 4001 may also be, for example, a combination that implements computing functionality, for example, a combination of one or more microprocessors, a combination of a DSP and a microprocessor, or the like.

The at least one processor 4001 may individually or collectively execute code, instructions, and/or applications stored in the memory 4003 to cause the electronic device 4000 to perform the operations described above. Although some description above uses mathematical notation, it will be appreciated that source code can be readily formed to mirror the mathematical notation, and instructions generated from compilation of such source code may be executed by the processor 4001 to cause the processor 4001 to perform the methods and operations described herein.

The bus 4002 may include a path for transferring information between the components described above. The bus 4002 may be a peripheral component interconnect (PCI) bus or an extended industry standard architecture (EISA) bus. The bus 4002 may be classified into an address bus, a data bus, a control bus, or the like. For illustrative purposes, only one bold line is shown in FIG. 8, but there is not necessarily only one bus or only one type of bus.

The memory 4003 may store instructions (or programs) executable by the at least one processor 4001. The instructions may include, for example, instructions for executing operations of the at least one processor 4001 and/or instructions for executing operations of each component of the at least one processor 4001.

The memory 4003 may include one or more computer-readable storage media. The memory 4003 may include a non-volatile storage device (e.g., a magnetic hard disc, an optical disc, a floppy disc, a flash memory, an electrically programmable read-only memory (EPROM), and an electrically erasable programmable read-only memory (EEPROM)).

The memory 4003 may be a non-transitory medium. The term “non-transitory” may indicate that the storage medium is not implemented as a carrier or propagated signal. However, the term “non-transitory” should not be construed to mean that the memory 4003 is immovable.

The example embodiments of the present disclosure may provide a computer-readable storage medium on which a computer program or instructions are stored, and when the computer program or instructions are executed by at least one processor, the steps and operations of the methods described herein may be implemented.

The example embodiments of the present disclosure may also provide a computer program product including the computer program (in the form of instructions) that, when executed by the processor, implements the steps and operations of the methods described herein.

The terms used herein, such as, “first,” “second,” “third,” “fourth,” “initial(ly),” “subsequent(ly),” and the like, may not be used to define an essence, order, or sequence of the steps or operations of the methods described herein but may be used only to distinguish the steps or operations of the methods. For example, the sequences of operations described herein are merely examples, and are not limited to those set forth herein, but may be changed as will be apparent after an understanding of the disclosure of this application, with the exception of operations necessarily occurring in a certain order.

The examples described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as, parallel processors.

The software applications may include a computer program, a piece of code, an instruction, or some combination thereof, to independently or collectively instruct and/or configure the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded in the media may be specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as ROM, RAM, flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

The computing apparatuses, the vehicles, the electronic devices, the processors, the memories, the image sensors, the vehicle/operation function hardware, the driving systems, the displays, the information output system and hardware, the storage devices, and other apparatuses, devices, units, modules, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method performed by an electronic device, comprising:
acquiring first data and second data; and
acquiring, based on the first data, a first map image corresponding to the first data, using a first artificial intelligence (AI) network,
acquiring, based on the second data, a second map image corresponding to the second data, using the first AI network
wherein the acquiring of the first map image comprises:
based on the first data comprising only one data type, acquiring the first map image based on a first feature extracted from the first data using an encoder corresponding to the only one data type; and
wherein the acquiring of the second map image comprises:
based on the second data comprising data of two data types, generating the second map image based on a second feature acquired from data of the two data types, wherein the second feature acquired is acquired by fusing together features extracted respectively from the data of the two data types using encoders respectively corresponding to the two data types.

2. The method of claim 1, wherein the acquiring of the first map image comprises:
enhancing the first feature using a mapping network of the first AI network, based on the first feature of the first data, to acquire a third feature corresponding to the first data; and
acquiring, based on the third feature, the first map image using a decoder of the first AI network.

3. The method of claim 2, wherein the enhancing of the first feature comprises:
enhancing the first feature using a first mapping network or a second mapping network different from the first mapping network to acquire the third feature.

4. The method of claim 3, wherein the acquiring of the first map image corresponding to the first data using the decoder of the first AI network based on the third feature comprises:
in response to the third feature being acquired using the first mapping network, acquiring the first map image using the decoder of the first AI network based on the third feature and the first feature.

5. The method of claim 1, wherein the first feature comprises:
a bird's eye view (BEV) feature, and
each of the second features comprises:
a respective other BEV feature.

6. The method of claim 1, wherein the first data comprises:
image data collected via a camera or point cloud data collected via a LiDAR.

7. The method of claim 1, further comprising:
determining a data type of data comprised in the first data.

8. A method performed by an electronic device, comprising:
acquiring a training data set comprising first samples and second samples respectively related to the first samples, wherein the first samples and the second samples are of different types;
acquiring, based on the training data set, a fourth feature related to each first sample, a fifth feature related to each second sample, and a sixth feature of each first sample and each second sample related to each first sample, using a second artificial intelligence (AI) network;
performing a prediction using the second AI network, based on the fourth feature, the fifth feature, and the sixth feature, to acquire a prediction result corresponding to each sample of the training data set; and
training the second AI network based on the prediction result to acquire a first AI network.

9. The method of claim 8, wherein the prediction result comprises:
a first image corresponding to each first sample, a second image corresponding to each second sample, and a third image corresponding to each first sample and each second sample related to each first sample.

10. The method of claim 8, wherein the acquiring of the fourth feature related to each first sample, the fifth feature related to each second sample, and the sixth feature of each first sample and each second sample related to each first sample, using the second AI network, based on the training data set, comprises:
acquiring the fourth feature using an encoder corresponding to a type of each first sample;
acquiring the fifth feature using an encoder corresponding to a type of each second sample; and
acquiring the sixth feature by fusing the fourth feature of each first sample and the fifth feature of each second sample related to each first sample.

11. The method of claim 8, wherein the performing of the prediction using the second AI network comprises:
enhancing the fourth feature, the fifth feature, and the sixth feature, using a mapping network of the second AI network; and
acquiring the prediction result, using a decoder of the second AI network, based on the enhanced fourth feature, the enhanced fifth feature, and the enhanced sixth feature.

12. The method of claim 8, wherein the training of the second AI network comprises:
determining, based on a prediction result corresponding to a group of related samples among the first and second samples, a training loss corresponding to the group of the related samples, wherein the group of the related samples comprises image data and point cloud data collected at the same point in time; and
training the second AI network using the training loss.

13. An electronic device, comprising:
one or more processors; and
a memory storing instructions,
wherein the instructions cause, based on being executed individually or collectively by the one or more processors, the electronic device to perform operations comprising:
acquiring first data comprising at least one data type; and
acquiring, based on the first data, a map image corresponding to the first data, using a first artificial intelligence (AI) network,
wherein the acquiring of the map image comprises:
in response to the first data comprising only one data type, acquiring the map image based on a first feature extracted from the first data using an encoder corresponding to the one data type; or
in response to the first data comprising two data types, acquiring the map image based on a first feature acquired from the two data types, wherein the first feature acquired from the two data types is acquired by fusing respective second features extracted respectively from the two data types using encoders corresponding to the data types, respectively.

14. The electronic device of claim 13, wherein the acquiring of the map image corresponding to the first data using the first AI network based on the first data comprises:
enhancing the first feature using a mapping network of the first AI network, based on the first feature of the first data, to acquire a third feature corresponding to the first data; and
acquiring the map image corresponding to the first data using a decoder of the first AI network, based on the third feature.

15. The electronic device of claim 14, wherein the electronic device is configured such that the enhancing of the first feature can be performed by either a first mapping network or a second mapping network different, either of which can acquire the third feature.

16. The electronic device of claim 15, wherein the acquiring of the map image corresponding to the first data comprises:
in response to the third feature being acquired using the first mapping network, acquiring the map image using the decoder of the first AI network, based on the third feature and the first feature.

17. The electronic device of claim 13, wherein the first feature comprises:
a bird's eye view (BEV) feature, and
each of the second features comprises:
a respective other BEV feature.

18. The electronic device of claim 13, wherein the first data comprises:
at least one of image data collected via a camera or point cloud data collected via a light detection and ranging (LiDAR) sensor.

19. The electronic device of claim 13, wherein the operations further comprise:
determining a data type of data comprised in the first data.

20. A computer-readable storage medium storing instructions, wherein the instructions, when executed by at least one processor, cause the one or more processors to implement the method according to claim 1.
